(19) United States
(12) Patent Application Publication
(10) Pub. No.: US 2015/0226544 A1
(43) Pub. Date: Aug. 13, 2015

(54) OPTICAL PROBE, ATTACHABLE COVER, AND SHAPE MEASURING APPARATUS

(71) Applicant: MITUTOYO CORPORATION, Kanagawa (JP)

(72) Inventors: Kentaro NEMOTO, Kawasaki-shi (JP); Masaoki YAMAGATA, Kawasaki-shi (JP); Eisuke MORIUCHI, Kawasaki-shi (JP); Tadashi IWAMOTO, Hino (JP)

(73) Assignee: MITUTOYO CORPORATION, Kanagawa (JP)

(21) Appl. No.: 14/612,480

(22) Filed: Feb. 3, 2015

(30) Foreign Application Priority Data
Feb. 7, 2014 (JP) JP2014-022767

(51) Int. Cl. G01B 11/24; G02B 5/02; G02B 1/11

(52) U.S. Cl. CPC G01B 11/24; G02B 1/11; G02B 5/0278

(57) ABSTRACT

An optical probe includes a probe cover, within which is installed an optical system having an illuminating optical system and a receiving optical system. An emitting region and an incidence region through which light passes are provided to a bottom surface of the probe cover, the bottom surface forming an opposing region opposite a work piece. In addition, a light reflection prevention structure or a diffusion structure is provided to the bottom surface of the probe cover. Light reflected from the work piece is prevented from reflecting off the bottom surface by the reflection prevention structure, or the reflected light is diffused by the diffusion structure. Accordingly, an occurrence of an erroneous value in received light distribution due to second order reflected light can be inhibited.

### CROSS-REFERENCE TO RELATED APPLICATIONS

The present application claims priority under 35 U.S.C. §119 of Japanese Application No. 2014-022767, filed on Feb. 7, 2014, the disclosure of which is expressly incorporated by reference herein in its entirety.

### BACKGROUND OF THE INVENTION

1. Field of the Invention

The present disclosure relates to an optical probe or the like measuring a shape of a measured object without contacting the measured object.

2. Description of Related Art

Conventional examples of a non-contact measuring apparatus measuring a shape of a measured object include a device employing a light-section measurement method. In the light-section method, light having a linear shape is emitted at the measured object and the reflected light is received by a two-dimensional photoreceiver element, for example. Received light distribution obtained by the photoreceiver element is amplified by an amplifier, after which it is digitalized and a cross-sectional shape of the measured object is detected based on a peak position in the digital data.

Japanese Patent Laid-open Publication No. 2012-230097 discloses, for example, an optical probe that includes a DMD (Digital Micro-mirror Device) selectively reflecting light having a linear shape based on a line direction of the light and emitting the light at a measured object. The DMD does not emit light at a predetermined region selected from a single line where the light is emitted on a surface region of the measured object. Therefore, the DMD can inhibit the occurrence of erroneous values (false images) due to light received from multiple reflections (see, e.g., paragraphs [0008] and [0026] of the specification of Japanese Patent Laid-open Publication No. 2012-230097).

One circumstance of multiple reflection is that, in a case where a surface of a measured object has comparatively high reflectivity (i.e., is a mirror surface), for example, directly reflected light from the measured object returns to the probe, then that light is further reflected by the probe and is directed toward the measured object. When such reflection subsequent to reflection off the probe is defined as second order reflection, a photoreceptor element receives the second order reflected light, and thus an erroneous value occurs in the received light distribution.

The present disclosure provides an optical probe, an attachable cover, and a shape measuring apparatus capable of inhibiting an occurrence of an erroneous value in received light distribution due to second order reflected light even when a surface of a measured object has comparatively high reflectivity.

### SUMMARY OF THE INVENTION

An optical probe according to one aspect of the present disclosure includes a probe cover, an optical system, and a light reflection prevention structure or diffusion structure. The probe cover includes an opposing region opposite a measured object, and an emitting region and an incidence region through which light passes, the emitting region and the incidence region being provided to the opposing region. The optical system is provided within the probe cover, emits light via the emitting region, and receives light reflected by the measured object via the incidence region. The light reflection prevention structure or the diffusion structure are provided to at least the opposing region of the probe cover.

Light reflected from the measured object is prevented from reflecting off the opposing region of the probe cover by the reflection prevention structure; alternatively, light reflected from the measured object is diffused by the diffusion structure. Accordingly, even in a case where reflectivity of the surface of the measured object is comparatively high, the occurrence of second order reflected light can be inhibited and, as a result, the occurrence of erroneous values in the received light distribution can be suppressed.

The reflection prevention structure or the diffusion structure may also be additionally provided to side surfaces of the probe cover. Accordingly, reflection of light incident on the side surfaces of the probe cover is also prevented or diffused, and thus the occurrence of erroneous values can be more reliably reduced.

The reflection prevention structure may also be a reflection prevention film. The diffusion structure may also be rough surface machined or hologram processed.

The optical probe further includes an attachable cover provided so as to be attachable and detachable with respect to the probe cover, the attachable cover including the reflection prevention structure or the diffusion structure. By mounting the attachable cover on a probe cover not having a reflection prevention structure or diffusion structure, the occurrence of second order reflected light can be inhibited and the occurrence of erroneous values in received light distribution can be suppressed.

An attachable cover according to another aspect of the present disclosure includes a mounting portion, an opposing portion, and a light reflection prevention structure or diffusion structure. The mounting portion is capable of connecting to a probe cover that includes an opposing region opposite a measured object, and an emitting region and an incidence region through which light passes, the emitting region and the incidence region being provided to the opposing region. The opposing portion includes an opening facing each of the emitting region and the incidence region in a state where the attachable cover is mounted on the probe cover so as to cover the opposing region. The light reflection prevention structure or the diffusion structure is provided to the opposing region.

In the state where the attachable cover is mounted on the probe cover by the mounting portion, light reflected from the measured object is prevented from reflecting off the opposing region of the probe cover by the reflection prevention structure; alternatively, light reflected from the measured object is diffused by the diffusion structure. Accordingly, even in a case where reflectivity of the surface of the measured object is comparatively high, the occurrence of second order reflected light can be inhibited and, as a result, the occurrence of erroneous values in the received light distribution can be suppressed.

A shape measuring apparatus according to another aspect of the present disclosure includes the optical probe, a stage, and a measurement processor. A measured object is placed on the stage. The measurement processor measures a shape of the measured object placed on the stage based on signals obtained by the optical probe.

According to the present disclosure, even in a case where reflectivity of a surface of a measured object is comparatively high, an occurrence of an erroneous value in received light distribution due to second order reflected light can be inhibited.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a perspective view primarily illustrating a shape measuring apparatus according to an embodiment of the present disclosure;

FIG. 2 is a cross-sectional view schematically illustrating a configuration of an optical probe according to a first embodiment of the present disclosure;

FIG. 3 is a bottom surface view of the optical probe shown in FIG. 2;

FIG. 4 is an explanatory diagram illustrating a principle underlying a Scheimpflug optical system;

FIGS. 5A and 5B are, respectively, a Y direction and an X direction view of a state where a line laser bombards a triangular columnar work piece W; FIG. 5C is an observed image of the work piece obtained on an image capture plane of an image capture element;

FIG. 6 is an explanatory diagram illustrating a circumstance that arises when measuring a work piece having a mirror surface;

FIG. 7 illustrates shape measurement results for a work piece having a mirror surface, using a conventional probe;

FIG. 8A illustrates a profile obtained on the image capture plane when a horizontal, uniform mirror surface is measured using a probe according to the present disclosure;

FIG. 8B illustrates a profile obtained on the image capture plane when the mirror surface is similarly measured using a conventional probe; and

FIGS. 9A and 9B are cross-sectional views schematically illustrating a probe according to a second embodiment of the present disclosure.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the forms of the present invention may be embodied in practice.

Hereafter, embodiments of the present disclosure are described with reference to the drawings.

### First Embodiment

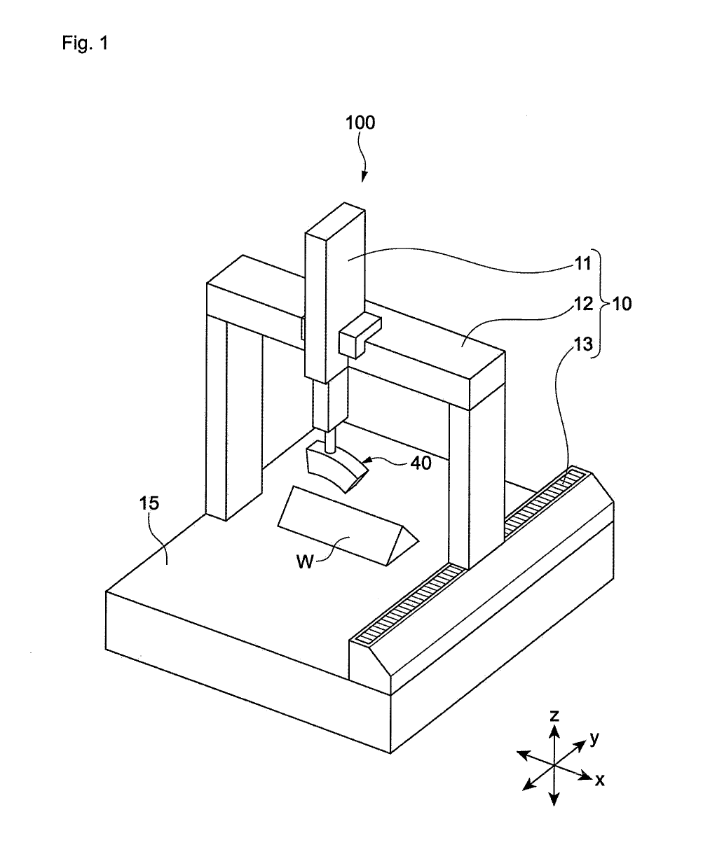

FIG. 1 is a perspective view primarily illustrating a shape measuring apparatus according to an embodiment of the present disclosure. A shape measuring apparatus 100 includes an optical probe (hereafter referred to as “probe”) 40, a stage 15, and a displacement mechanism 10.

A work piece W is placed on the stage 15 as a measured object. The displacement mechanism 10 is configured to enable the probe 40 to be displaced in three dimensions (X, Y, Z). Specifically, the displacement mechanism 10 includes a Z displacement mechanism 11 displacing the probe 40 along the Z direction; an X displacement mechanism 12 displacing the Z displacement mechanism 11 along the X direction; and a Y displacement mechanism 13 integrally displacing the Z displacement mechanism 11 and the X displacement mechanism 12 in the Y direction.

The shape measuring apparatus 100 is connected to a control device (not shown in the drawings) configured by a computer, for example. The control device controls driving of the displacement mechanism 10. In addition, the control device includes a measurement processor measuring a shape of the work piece W based on signals obtained from the probe 40. Information generated by the measurement processor is displayed on a display (not shown in the drawings).

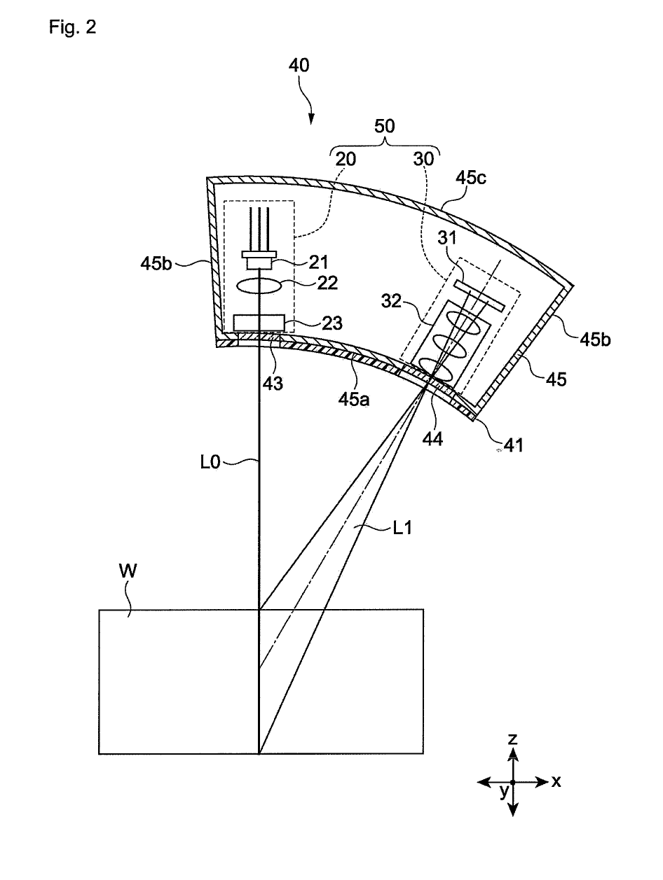

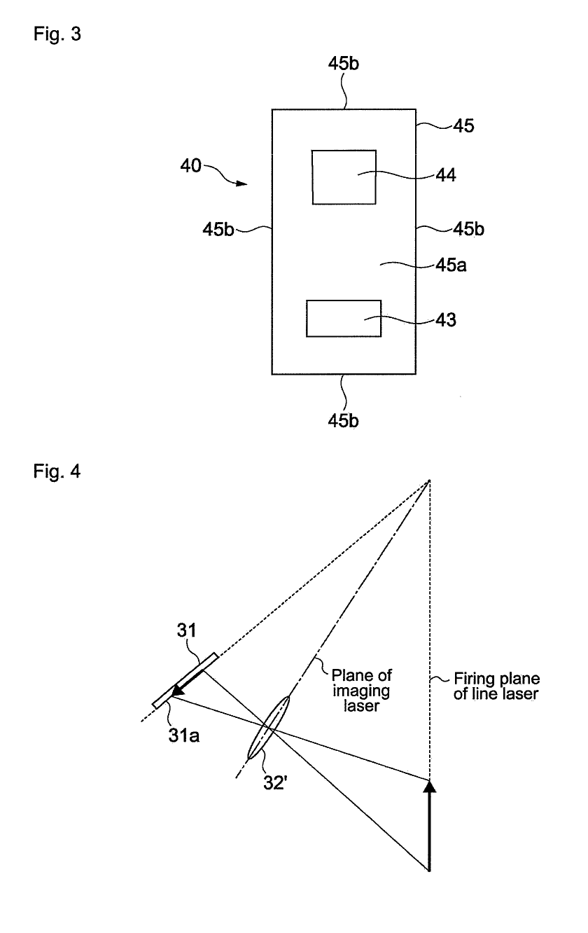

FIG. 2 is a cross-sectional view schematically illustrating a configuration of the probe 40. FIG. 3 is a view from a bottom surface 45a of the probe 40. The probe 40 includes a probe cover 45 and an optical system 50 installed within the probe cover 45.

The probe cover 45 has, for example, an arced block shape (the shape of a portion of a ring) or another very similar shape. A surface of the probe cover 45 includes a top surface 45c, four side surfaces 45b, and the bottom surface 45a, the bottom surface 45a forming an opposing region opposite the work piece W placed on the stage 15.

The optical system 50 includes an illuminating optical system 20 and a receiving optical system 30. The illuminating optical system 20 includes a laser diode 21 as a light source; a collimator lens 22 rendering laser light from the laser diode 21 into parallel light; and a linear light generating element 23 generating a line-shaped laser LO in one direction (herein, the Y direction) from the parallel laser light. A rod lens, for example, is used as the linear light generating element 23.

The receiving optical system 30 includes an imaging lens unit 32 having a plurality of lenses, and an image capture element 31. Examples of the image capture element 31 used may include a CCD (Charge Coupled Device) or a CMOS (Complementary Metal-Oxide Semiconductor) device.

The laser light emitted from the illuminating optical system 20 is emitted via an emitting region 43 provided to the bottom surface 45a of the probe cover 45. The emitted laser light LO is emitted (or fired) toward at the work piece W as a line laser. Reflected light L1 reflected by the work piece W strikes the receiving optical system 30 via an incidence region 44 provided to the bottom surface 45a of the probe cover 45.

The probe cover 45 is configured with resin or metal as a primary material. The emitting region 43 and the incidence region 44 are configured with a material transparent to the laser light generated by the illuminating optical system 20. The material configuring the emitting region 43 and the incidence region 44 is an acrylic or glass in a case where the laser light is visible light, for example.

Moreover, at least one of the emitting region 43 and the incidence region 44 may be an aperture formed by having an opening in the probe cover 45.

A principle underlying a Scheimpflug optical system is applied to the optical system 50 of the probe 40. FIG. 4 is an explanatory diagram illustrating the principle underlying the Scheimpflug optical system. The Scheimpflug principle states that in a case an image capture plane 31a of the image capture element 31, a principal plane that includes a focal point of an imaging lens 32′, and a firing plane (also referred to as the emitting plane) of the line laser emitted at the work piece W are each positioned so as to extend and intersect at a straight line (single point in FIG. 4), the entire image capture plane 31a of the image capture element 31 is in focus. In the present embodiment, by using the Scheimpflug optical system, the entire image capture plane 31a is in focus in the Y and Z directions in a range where the line laser is emitted.

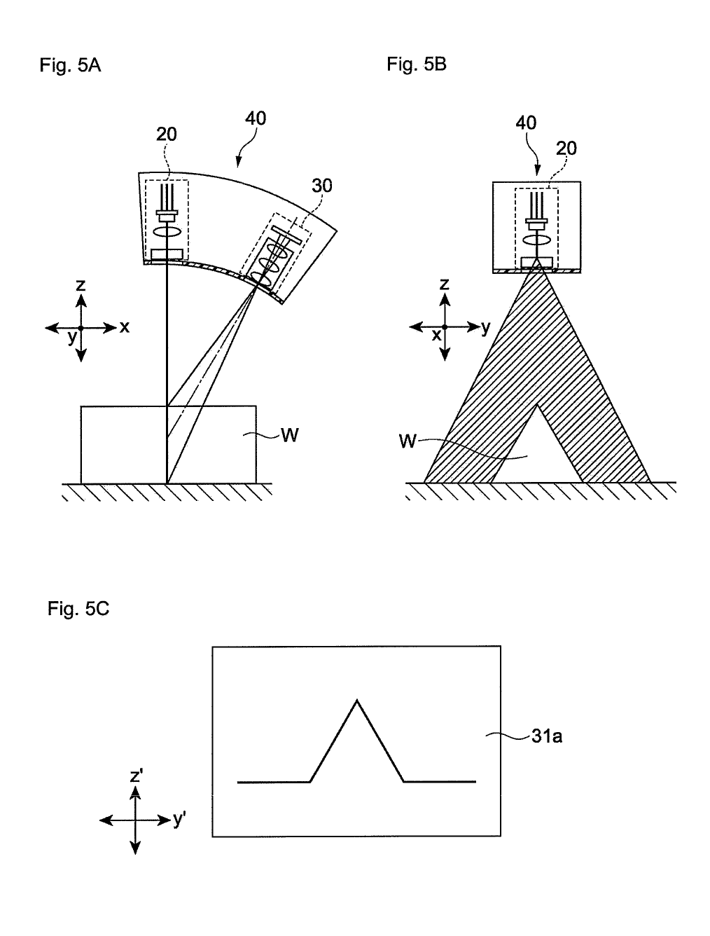

FIGS. 5A and 5B are, respectively, a Y direction and an X direction view of a state where the line laser from the probe 40 is emitted at the work piece W having, for example, a triangular columnar shape. FIG. 5C is an observed image of the work piece obtained on the image capture plane 31 a of the image capture element 31 in such a case.

The shape of the work piece W in the Y direction (line direction of the line laser) corresponds to a shape of a Y′ direction signal on the image capture plane 31a. The shape of the work piece W in the Z direction of the line laser corresponds to a shape of a Z′ direction signal on the image capture plane 31a. Due to the X displacement mechanism 12 scanning the probe 40 in the X direction, the entire shape of the work piece W can be measured. Spatial coordinate values calculated based on (a trajectory of) a peak value of an amount of light received for each pixel obtained by the image capture element 31 form the measured shape.

Peak detection is performed by the measurement processor. For example, the measurement processor detects a pixel position having a peak value (i.e., a peak position) from among a row of pixels along the Z′ direction on the image capture plane 31a. By repeating this process along a direction orthogonal to the row of pixels (i.e., along the Y′ direction), shape measurement can be performed for one line.

Herein, in a case where the work piece has a surface with high diffusion, a diffusion component of the light reflected by the surface of the work piece W is stronger while a reflected component (herein, a reflected component that is nearly a direct reflection) is weaker. Moreover, multiple reflection attenuates the light commensurate with the number of reflections. Therefore, a second order reflection following reflection off the probe cover does not have sufficient intensity to be mistakenly detected as a peak.

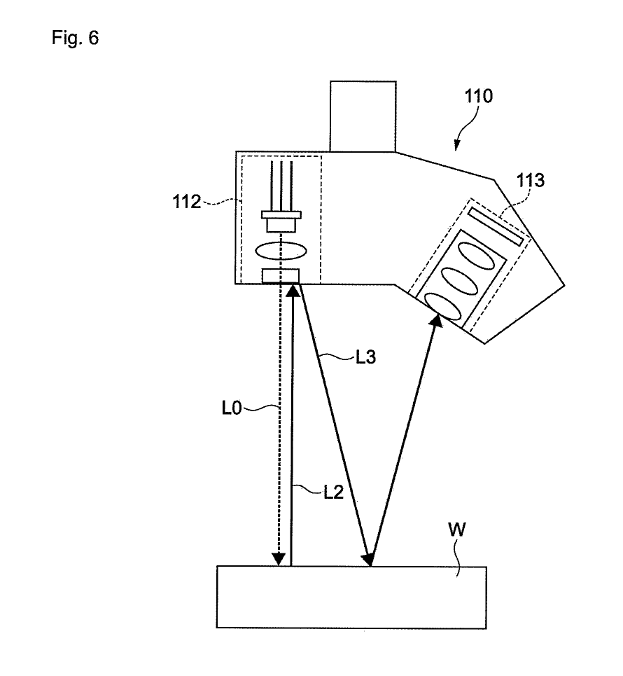

However, a case where the work piece W has a surface with a comparatively high reflectivity, such as a mirror surface, for example, gives rise to the following situation. FIG. 6 illustrates this situation. As shown in the drawing, when the laser light L0 emitted from an optical probe 110 is emitted at the work piece W having the mirror surface, the intensity of the light in the direct reflection direction (i.e., directly reflected light L2) is greater. On the bottom surface of the probe 110, the directly reflected light L2 is reflected by an emitting region of an illuminating optical system 112 and a surrounding area, and that reflected light L3 is once again emitted at the work piece W. Specifically, a second order reflection occurs on the bottom surface of the probe 110. When an image capture element catches light belonging to the second order reflected light reflected by the work piece W and incident on a receiving optical system 113 of the probe 110, an image of the light is a false image and is mistakenly detected as a peak, thus leading to an erroneous value.

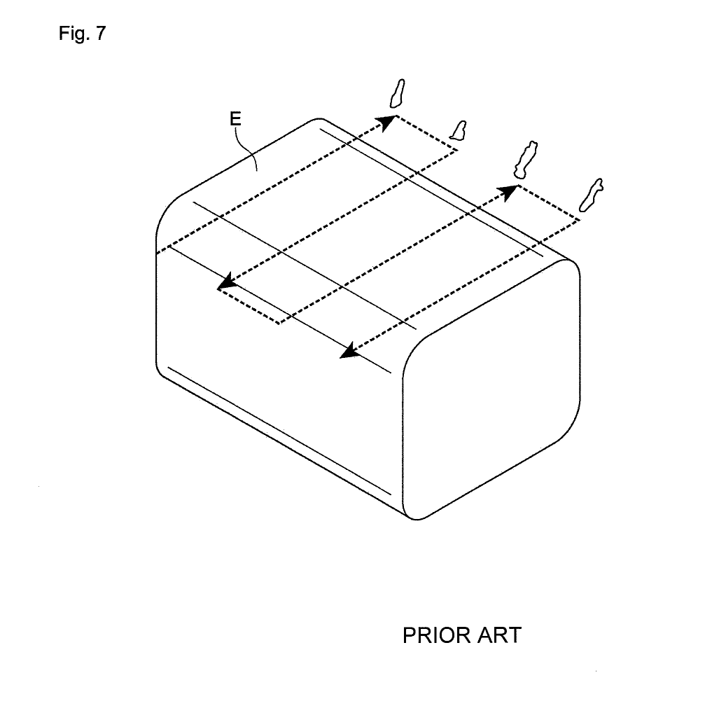

FIG. 7 illustrates an exemplary image of shape measurement results for a work piece having a mirror surface using a conventional probe. The shape of the work piece is, for example, a rectangular parallelepiped having an angle R. As shown in the drawing by the portions delineated by dashed lines, due to the occurrence of second order reflection, erroneous values (false images) for a received light distribution are detected at portions of the work piece having the angle R.

In order to prevent the occurrence of such erroneous values, the probe 40 according to the present embodiment includes a reflection prevention structure (also referred to as a reflection prevention surface) 41 on the bottom surface 45a of the probe cover 45, as shown in FIG. 2. A reflection prevention film, for example, can be used as the reflection prevention structure 41.

The reflection prevention film is formed on regions of the bottom surface 45a, excepting the emitting region 43 and the incidence region 44.

The reflection prevention film is a film configured by a low-reflectivity material capable of reducing the influence of second order reflected light and is, for example, configured by a single layer or multiple layers of a material such as oxides or fluorides of Mg, Zr, Ti, or Si. Alternatively, the reflection prevention film may also be a photo-absorbent material having a nanostructure.

Even in a case where the reflectivity of the surface of the work piece W is comparatively high, the occurrence of second order reflected light from the work piece W can be inhibited by the reflection prevention structure 41 and, as a result, erroneous values for the received light distribution can be suppressed.

Instead of the reflection prevention structure, a diffusion structure (also referred to as a “diffuser”) diffusing light may be provided to at least the bottom surface 45a of the probe cover 45. A surface forming the diffusion structure is rough surface machined or hologram processed, for example. Examples of rough surface machining include sandblasting, or machining unevenness having a shape with a desired design. With such a diffusion structure, high intensity light in the direct reflection direction from the work piece W can be diffused. Even when a portion of the diffused light strikes a photoreception region, the light is attenuated to the point of not being problematic (i.e., to the point that the occurrence of erroneous values can be suppressed).

The structure (material) of at least a bottom portion (opposing region) of the probe cover may also be a reflection prevention structure or a diffusion structure. Specifically, an encasement structure of at least the bottom portion of the probe cover may also be configured by the reflection prevention structure or the diffusion structure. Naturally, the encasement structure of the entire probe cover may also be configured by or defined the reflection prevention structure or the diffusion structure.

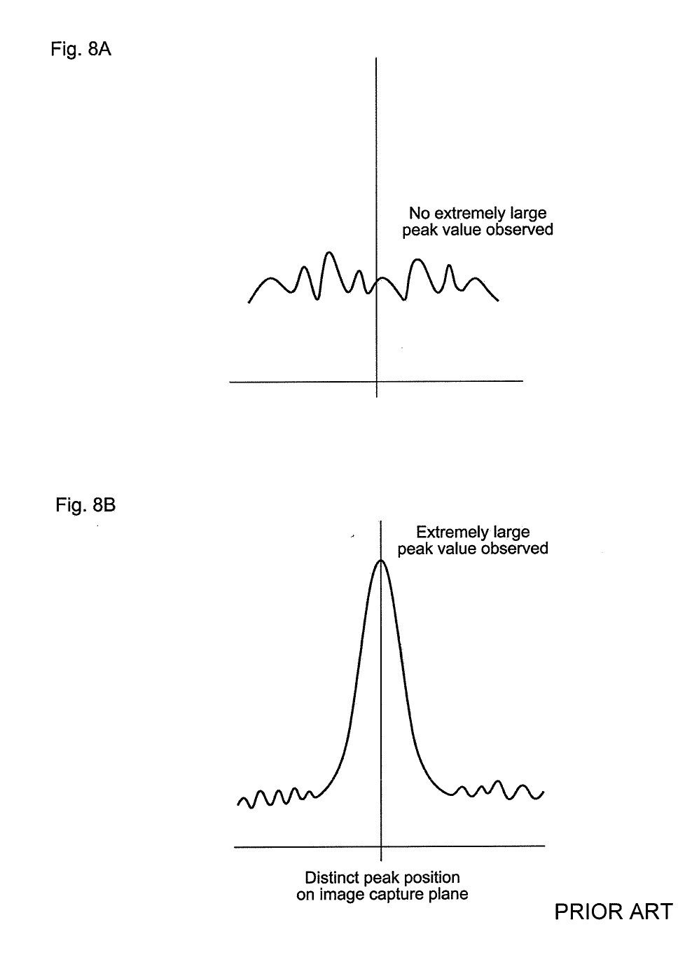

FIG. 8A illustrates a profile obtained with a row of pixels, from among rows of pixels along the Z′ direction on the image capture plane 31a, corresponding to a position where a false image occurs when a horizontal, uniform mirror surface is measured using the probe 40 according to the present embodiment. FIG. 8B illustrates a profile obtained with a row of pixels, from among rows of pixels along the Z′ direction on an image capture plane, corresponding to a position where a false image occurs when the mirror surface is similarly measured using a conventional probe.

In FIG. 8B, image capture element receives the high-intensity second order reflected light, and accordingly detects a locally large peak value, defining the peak position. In this way, an extremely large peak value becomes an erroneous value.

In contrast, in FIG. 8A, no extremely large peak value is detected. Specifically, the occurrence of high-intensity second order reflected light is inhibited by the reflection prevention structure 41 or the diffusion structure, and thus the occurrence of an erroneous value can be inhibited. Thereby, measurement data can achieve better accuracy and higher quality.

In addition, the conventional probe required work to verify the occurrence of and eliminate erroneous values; however, such work is unnecessary in the present embodiment and so work time can be reduced and workload can be alleviated.

In the above-noted embodiment, the reflection prevention structure 41 or the diffusion structure are provided only to the bottom surface 45a. However, these structures may also be additionally provided to at least one of the four side surfaces 45b of the probe cover 45, or to the entire surface of the probe cover 45.

### Second Embodiment

Hereafter, a probe according to a second embodiment of the present disclosure is described. In the description that follows, identical reference numerals are assigned to elements that are essentially similar to components and functions encompassed by the probe 40 according to the embodiment depicted in FIG. 1 and elsewhere. A description of these elements is simplified or omitted in the interest of focusing on dissimilar features.

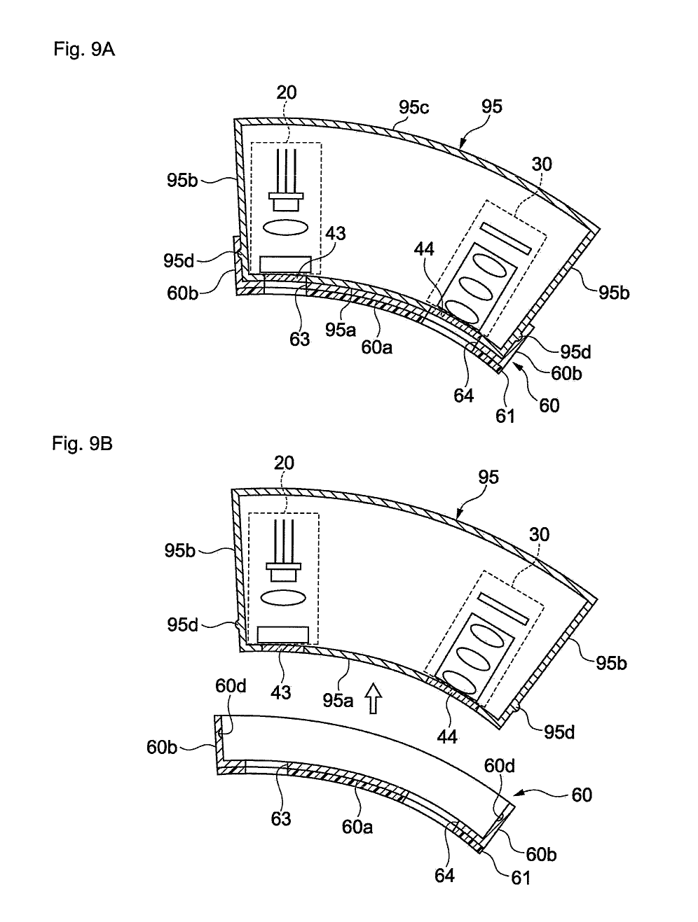

FIGS. 9A and 9B are cross-sectional views schematically illustrating a probe according to a second embodiment of the present disclosure. As shown in FIG. 9A, an attachable cover 60 is mounted to a probe cover 95 for this probe such that a bottom surface 95a (opposing region opposite the work piece W) is covered. As shown in FIG. 9B, a projection 95d is provided to a bottom portion of side surfaces 95b of the probe cover 95, the projections 95d being capable of connecting by latching to an indentation 60d (mounting portions) provided on an inner surface of side walls 60b of the attachable cover 60. The projections 95d are provided on a portion or around the entire periphery of the side surfaces 95b, and the indentations 60d are provided at positions corresponding to those of the projections 95d. In this way, the attachable cover 60 can be attached and detached with respect to the probe cover 95.

Openings 63 and 64 are provided to the attachable cover 60 at positions facing the emitting region 43 and the incidence region 44, respectively, of the probe cover 95. A component configured by a light-transmissive material may also be provided at the openings 63 and 64.

In addition, a reflection prevention structure 61 similar to the above-described reflection prevention structure 41 is provided to a bottom surface 60a (opposing portion or opposing cover opposite the work piece) of the attachable cover 60. A diffusion structure may be used instead of the reflection prevention structure 61, as described above. In a case where transparent components are provided to the openings 63 and 64, the reflection prevention structure 61 can also be provided to the entire bottom surface 60a, including over the transparent components.

By mounting the attachable cover 60 on the probe cover 95, the reflection prevention structure 61 is formed on the bottom surface 95a of the probe cover 95, via the bottom surface 60a of the attachable cover 60. The attachable cover 60 is mounted on the probe cover 95 and measurement is performed, and thereby the occurrence of second order reflection and erroneous values in the received light distribution can be inhibited.

In the present embodiment, projections may instead be provided to the inner surface of the side walls 60b of the attachable cover 60 and indentations provided to the side walls of the probe cover 95.

A “mount” mechanism according to the present embodiment is configured by latching the projections 95d with the indentations 60d. However, the present invention is not limited to this. A screw mechanism may also be used, or a contact mechanism using a material having a high friction coefficient, such as rubber.

With an attachable cover such as that according to the present embodiment, the attachable cover can be attached even to a probe already having a probe cover, for example, thereby achieving a probe capable of inhibiting second order reflection.

### Other Embodiments

The present invention is not limited to the above-described embodiments, and various other embodiments can be used.

In the above-noted embodiment, various surfaces configuring the surface of the probe cover are described as a “top surface,” “bottom surface,” and “side surface;” however, this notation is used merely to facilitate understanding. For example, in a case where, rather than being attached to the shape measuring apparatus 100 as shown in FIG. 1, a probe is attached to a multi joint arm and a worker manually operates the arm to perform measurement, an orientation of the probe is not restricted to up/down and left/right directions but instead may have an arbitrary orientation.

The laser diode 21, which generates coherent light, is used as the light source of the illuminating optical system 20 according to the above-described embodiment; however, an LED (Light Emitting Diode) or the like may also be used.

The linear light generating element 23 according to the above-described embodiment is a rod lens; however, instead, a light scanning element capable of scanning light in a linear shape may also be used, such as a DMD, a galvano-mirror element, or a polygonal mirror element.

The probe according to the above-described embodiment applies the principle of a Scheimpflug optical system; however, the probe is not necessarily limited to this and may instead employ a generic, reflection-type light sensor.

The shape of the probe covers 45 and 95 is not limited to the arced block shape noted above. For example, the overall shape of the probe cover may also be a rectangular parallelepiped and the bottom surface (opposing region) may be configured by a plurality of planes. In such a case, the attachable cover may also have a shape corresponding to that of the probe cover.

In the shape measuring apparatus 100 according to the above-described embodiment, the probe is oriented such that an emission optical axis of the illuminating optical system 20 lies along the Z direction; however, the probe may also be oriented such that the emission optical axis is inclined.

At least two characteristic features of each embodiment described above may also be combined.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

What is claimed is:

1. An optical probe comprising:
a probe cover comprising:
an opposing region opposite a measured object; and
an emitting region and an incidence region through which light passes, the emitting region and incidence region being provided to the opposing region;
an optical system provided within the probe cover and configured to emit light via the emitting region, and further configured to receive light reflected by the measured object via the incidence region; and
one of a light reflection prevention surface structure and a diffuser provided to at least the opposing region of the probe cover.

2. The optical probe according to claim 1, wherein the one of the light reflection prevention surface structure and the diffuser is additionally provided to side surfaces of the probe cover.

3. The optical probe according to claim 1, wherein the reflection prevention surface is a reflection prevention film.

4. The optical probe according to claim 2, wherein the reflection prevention surface is a reflection prevention film.

5. The optical probe according to claim 1, wherein the diffuser is a surface that is one of rough surface machined and hologram processed.

6. The optical probe according to claim 2, wherein the diffuser is a surface that is one of rough surface machined and hologram processed.

7. The optical probe according to claim 1 further comprising an attachable cover which is provided so as to be attachable and detachable with respect to the probe cover, the attachable cover comprising the one of the light reflection prevention surface structure and the diffuser.

8. The optical probe according to claim 1, wherein an encasement of at least the opposing region of the probe cover is defined by the one of the light reflection prevention surface structure and the diffuser reflection prevention structure or the diffusion structure.

9. An attachable cover comprising:
a mount configured to connect to a probe cover, the probe cover including an opposing region opposite a measured object, and an emitting region and an incidence region through which light passes, the emitting region and incidence region provided to the opposing region;
an opposing cover comprising an opening facing each of the emitting region and the incidence region in a state where the attachable cover is mounted on the probe cover so as to cover the opposing region; and
one of a light reflection prevention surface structure and a diffuser provided to at least the opposing region of the probe cover

10. A shape measuring apparatus comprising:
an optical probe comprising:
a probe cover having an emitting region configured to emit light, an incidence region where light reflected from a measured object strikes, and an opposing region opposite a measured object and including the emitting region and the incidence region;
an optical system provided within the probe cover and configured to emit light via the emitting region, and further configured to receive reflected light via the incidence region; and
one of a light reflection prevention surface structure and a diffuser provided to at least the opposing region of the probe cover;
a stage configured to accept the measured object thereon; and
a measurement processor configured to measure a shape of the measured object placed on the stage based on signals obtained by the optical probe.
